(19) United States
(12) Patent Application Publication
(10) Pub. No.: US 2023/0383428 A1
(43) Pub. Date: Nov. 30, 2023

(54) Fluidic Member for Use in an Electrolyzer System

(71) Applicant: Ticona LLC, Florence, KY (US)

(72) Inventors: Yuehua Yu, Cincinnati, OH (US); Pruthesh Vargantwar, Overland Park, KS (US)

(21) Appl. No.: 18/307,840

(22) Filed: Apr. 27, 2023

Related U.S. Application Data
(60) Provisional application No. 63/339,648, filed on May 9, 2022.

(51) Int. Cl. C25B 15/08; C25B 9/23; C25B 1/042; C08L 81/04; F16L 11/12

(52) U.S. Cl. CPC C25B 15/08; C25B 9/23; C25B 1/042; C08L 81/04; F16L 11/12

(57) ABSTRACT

An electrolyzer system comprising an electrochemical cell and an electrolyzer fluidic member utilized to supply a fluid to the electrochemical cell is provided. The electrolyzer fluidic member comprises a polymer composition that includes a polyarylene sulfide.

### RELATED APPLICATION

The present application is based upon and claims priority to U.S. Provisional Patent Application Ser. No. 63/339,648 having a filing date of May 9, 2022, which is incorporated herein by reference.

### BACKGROUND OF THE INVENTION

Electrolyzers require the supply of fuel, generally water, to the electrochemical reactor and removal of product, generally hydrogen and oxygen, from the electrochemical reactor by use of fluidic conveyance systems that incorporate fluidic members, e.g., pipes, hoses, connectors, fittings, etc. Additional fluidic members can be necessary, depending upon the type and style of electrolyzer, such as for recycle, addition or removal of electrolyte, fluid pumping, product/fuel separation or purification, filtration, temperature control, etc. Conventional fluidic members for conveying fluids to/from the electrochemical reactor or other components of a system are formed from silicone rubber or fluoropolymer materials. While such materials can exhibit a certain degree of flexibility and chemical resistance, they are relatively difficult and costly to form into the complex shapes often needed for the system. As such, a need currently exists for fluidic members that can be more readily incorporated into an electrolyzer system.

### SUMMARY OF THE INVENTION

In accordance with one embodiment of the present invention, an electrolyzer system is disclosed that comprises an electrochemical reactor cell and an electrolyzer fluidic member utilized in conveyance of a fluid (a gas, liquid, vapor, or any combination thereof) directly or indirectly to or from the electrochemical reactor cell. An electrolyzer fluidic member can be utilized in directly conveying a fluid to or from the anode side or cathode side of an electrochemical reactor cell as well in conveying a fluid to or from a secondary component of an electrolyzer system, e.g., a filter, a purifier, a heat exchanger, a demister, a separator, etc. and thereby utilized in indirectly conveying a fluid to or from the electrochemical reactor cell. The electrolyzer fluidic member comprises a polymer composition that includes a polyarylene sulfide.

Other features and aspects of the present invention are set forth in greater detail below.

### BRIEF DESCRIPTION OF THE DRAWING

A full and enabling disclosure of the present invention, including the best mode thereof to one skilled in the art, is set forth more particularly in the remainder of the specification, including reference to the accompanying figures, in which:

FIG. 1 is a schematic view of one embodiment of a proton exchange polymer electrolyte membrane (PEM) electrolyzer system of the present invention;

FIG. 2 is a schematic view of one embodiment of an alkaline electrolyzer system of the present invention;

FIG. 3 is a schematic view of one embodiment of an anion exchange PEM electrolyzer system of the present invention; and

FIG. 4 is a schematic view of one embodiment of a solid oxide electrolyzer cell (SOEC) system of the present invention.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to an electrolyzer system that includes at least one electrolyzer fluidic member. A fluidic member can be any component of an electrolyzer system that is utilized in conveying a fluid, i.e., a liquid, vapor, gas, or any combination thereof, within the electrolyzer system. For example and without limitation, a fluidic member can encompass a pipe, tube, hose, fitting, connector, etc. utilized in conveying a fluid within a system. A fluidic member can contact the fluid being conveyed, such as in the case of a pipe, tube, or hose, but need not directly contact the fluid, such as in the case of certain fittings and connectors.

The electrolyzer fluidic member contains a polymer composition that includes a polyarylene sulfide. An electrolyzer fluidic member can be a single layer or a multi-layer fluidic member, e.g., a multi-layer hose or pipe, with at least one layer of the fluidic member including a polymer composition as described. By selectively controlling the particular nature of the polyarylene sulfide and the nature and concentration of other components within the composition, it has been discovered that the resulting composition can exhibit a combination of characteristics that are uniquely suited for an electrolyzer fluidic member. For example, the polymer composition may exhibit a relatively low melt viscosity, such as about 2,000 Pa-s or less, in some embodiments about 1,000 Pa-s or less, in some embodiments about 800 Pa-s or less, and in some embodiments, from about 50 to about 600 Pa-s, as determined by a capillary rheometer at a temperature of about 310° C. and shear rate of 1,200 seconds⁻¹ in accordance with ISO 11443:2021. Nevertheless, the polymer composition may exhibit a high complex viscosity, which is a characteristic of high melt strength, such as about 1,000 Pa-s or more, in some embodiments about 1,500 Pa-s or more, and in some embodiments, from about 2,000 to about 10,000 Pa-s, as determined by a parallel plate rheometer at an angular frequency of 0.1 radians per second, temperature of 310° C., and constant strain amplitude of 3%.

Due to the relatively low melt viscosity, relatively high molecular weight polyarylene sulfides can also be employed with little difficulty. For example, such high molecular weight polyarylene sulfides may have a number average molecular weight of about 14,000 grams per mole (“g/mol”) or more, in some embodiments about 15,000 g/mol or more, and in some embodiments, from about 16,000 g/mol to about 60,000 g/mol, as well as weight average molecular weight of about 35,000 g/mol or more, in some embodiments about 50,000 g/mol or more, and in some embodiments, from about 60,000 g/mol to about 90,000 g/mol, as determined using gel permeation chromatography as described below. One benefit of using such high molecular weight polymers is that they generally have a low chlorine content. In this regard, the resulting polymer composition may have a low chlorine content, such as about 1200 ppm or less, in some embodiments about 900 ppm or less, in some embodiments from 0 to about 800 ppm, and in some embodiments, from about 1 to about 500 ppm.

Despite having a low melt viscosity, the polymer composition may nevertheless maintain a high degree of impact strength, which can provide enhanced flexibility for the resulting electrolyzer fluidic member. For example, the polymer composition may exhibit a notched Charpy impact strength of about 20 kJ/m² or more, in some embodiments from about 40 to about 150 kJ/m², and in some embodiments, from about 55 to about 100 kJ/m², as determined at a temperature of 23° C. in accordance with ISO Test No. 179-1:2010. Beneficially, the polymer product has a high degree of thermal resistance and thus can exhibit good impact strength at both high and low temperatures. For example, the polymer product can exhibit a notched Charpy impact strength of about 10 kJ/m² or more, in some embodiments from about 20 to about 100 kJ/m², and in some embodiments, from about 30 to about 80 kJ/m², as determined at a temperature of −30° C. in accordance with ISO Test No. 179-1:2010.

The tensile and flexural mechanical properties may also be good. For example, the composition may exhibit a tensile strength of about 20 MPa or more, in some embodiments from about 25 to about 200 MPa, in some embodiments from about 30 to about 150 MPa, and in some embodiments, from about 35 to about 100 MPa; a tensile break strain of about 20% or more, in some embodiments about 25% or more, in some embodiments about 30% or more, and in some embodiments, from about 35% to about 100%; and/or a tensile modulus of about 10,000 MPa or less, in some embodiments from about 500 MPa to about 8,000 MPa, in some embodiments from about 1,000 MPa to about 6,000 MPa, and in some embodiments, from about 1,500 MPa to about 5,000 MPa. The tensile properties may be determined in accordance with ISO Test No. 527:2019 at a temperature of 23° C. The composition may also exhibit a flexural strength of about 20 MPa or more, in some embodiments from about 25 to about 200 MPa, in some embodiments from about 30 to about 150 MPa, and in some embodiments, from about 35 to about 100 MPa and/or a flexural modulus of about 10,000 MPa or less, in some embodiments from about 500 MPa to about 8,000 MPa, in some embodiments from about 1,000 MPa to about 6,000 MPa, and in some embodiments, from about 1,500 MPa to about 5,000 MPa. The flexural properties may be determined in accordance with ISO Test No. 178:2019 at a temperature of 23° C.

The polymer composition may also be generally resistant to permeation of fluids that would typically be in contact with the electrolyzer fluidic member, such as hydrogen, oxygen, water, liquid electrolytes, liquid/gas mixtures, etc. For example, the polymer composition may have a hydrogen transmission rate of about 30 ml/m²*day or less, in some embodiments about 20 ml/m²*day or less, in some embodiments about 10 ml/m²*day or less, and in some embodiments, from about 0.1 to about 5 ml/m²*day, such as determined in accordance with ASTM D1434-82 (2015) (volumetric method) at a temperature of about 23° C. and pressure difference of 1 atmosphere. The polymer composition may likewise exhibit an oxygen transmission rate of about 30 ml/m²*day or less, in some embodiments about 20 ml/m²*day or less, in some embodiments about 10 ml/m²*day or less, and in some embodiments, from about 0.1 to about 5 ml/m²*day, such as determined in accordance with ASTM D1434-82 (2015) (volumetric method) at a temperature of about 23° C. and pressure difference of 1 atmosphere. The polymer composition may also be relatively pure in nature in that it contains a low level of extractable contaminants, such as about 2 mg/cm² or less, in some embodiments about 1.5 mg/cm² or less, and in some embodiments, about 0.5 mg/cm² or less of extractable compounds after contact with n-hexane (7 hours), acetone (7 hours), and/or deionized water (24 hours).

Various embodiments of the present invention will now be described in greater detail below.

### I. Polymer Composition

A. Polvarylene Sulfide

Polyarylene sulfides typically constitute from about 40 wt. % to about 100 wt. %, in some embodiments from about 50 wt. % to about 95 wt. %, and in some embodiments, from about 60 wt. % to about 90 wt. % of the polymer composition. The polyarylene sulfide(s) employed in the composition generally have repeating units of the formula:

—[(Ar¹)ₙ—X]ₘ—[(Ar²)ᵢ—Y]ᵢ—[(Ar³)ₖ—Z]ᵢ—[(Ar⁴)ₒ—W]ₚ—

wherein,

Ar¹, Ar², Ar³, and Ar⁴ are independently arylene units of 6 to 18 carbon atoms;

W, X, Y, and Z are independently bivalent linking groups selected from —SO₂—, —S—, —SO—, —CO—, —O—, —C(O)O— or alkylene or alkylidene groups of 1 to 6 carbon atoms, wherein at least one of the linking groups is —S—; and

n, m, i, j, k, I, o, and p are independently 0, 1, 2, 3, or 4, subject to the proviso that their sum total is not less than 2.

The arylene units Ar¹, Ar², Ar³, and Ar⁴ may be selectively substituted or unsubstituted. Advantageous arylene units are phenylene, biphenylene, naphthalene, anthracene and phenanthrene. The polyarylene sulfide typically includes more than about 30 mol %, more than about 50 mol %, or more than about 70 mol % arylene sulfide (—S—) units. For example, the polyarylene sulfide may include at least 85 mol % sulfide linkages attached directly to two aromatic rings. In one particular embodiment, the polyarylene sulfide is a polyphenylene sulfide, defined herein as containing the phenylene sulfide structure —(C₆H₄-S)ₙ— (wherein n is an integer of 1 or more) as a component thereof.

Synthesis techniques that may be used in making a polyarylene sulfide are generally known in the art. By way of example, a process for producing a polyarylene sulfide can include reacting a material that provides a hydrosulfide ion (e.g., an alkali metal sulfide) with a dihaloaromatic compound in an organic amide solvent. The alkali metal sulfide can be, for example, lithium sulfide, sodium sulfide, potassium sulfide, rubidium sulfide, cesium sulfide or a mixture thereof. When the alkali metal sulfide is a hydrate or an aqueous mixture, the alkali metal sulfide can be processed according to a dehydrating operation in advance of the polymerization reaction. An alkali metal sulfide can also be generated in situ. In addition, a small amount of an alkali metal hydroxide can be included in the reaction to remove or react impurities (e.g., to change such impurities to harmless materials) such as an alkali metal polysulfide or an alkali metal thiosulfate, which may be present in a very small amount with the alkali metal sulfide.

The dihaloaromatic compound can be, without limitation, an o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide or dihalodiphenyl ketone. Dihaloaromatic compounds may be used either singly or in any combination thereof. Specific exemplary dihaloaromatic compounds can include, without limitation, p-dichlorobenzene; m-dichlorobenzene; o-dichlorobenzene; 2,5-dichlorotoluene; 1,4-dibromobenzene; 1,4-dichloronaphthalene; 1-methoxy-2,5-dichlorobenzene; 4,4′-dichlorobiphenyl; 3,5-dichlorobenzoic acid; 4,4′-dichlorodiphenyl ether; 4,4′-dichlorodiphenylsulfone; 4,4′-dichlorodiphenylsulfoxide; and 4,4′-dichlorodiphenyl ketone. The halogen atom can be fluorine, chlorine, bromine, or iodine, and two halogen atoms in the same dihalo-aromatic compound may be the same or different from each other. In one embodiment, o-dichlorobenzene, m-dichlorobenzene, p-dichlorobenzene or a mixture of two or more compounds thereof is used as the dihalo-aromatic compound. As is known in the art, it is also possible to use a monohalo compound (not necessarily an aromatic compound) in combination with the dihaloaromatic compound in order to form end groups of the polyarylene sulfide or to regulate the polymerization reaction and/or the molecular weight of the polyarylene sulfide.

The polyarylene sulfide(s) may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

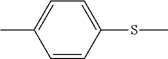

and segments having the structure of formula:

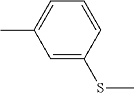

or segments having the structure of formula:

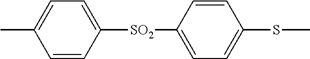

The polyarylene sulfide(s) may be linear, semi-linear, branched, or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xn, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′, 4,4′-tetrachlorobiphenyl, 2,2′, 5,5′-tetra-iodobiphenyl, 2,2′, 6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

If desired, the polyarylene sulfide can be functionalized. For instance, a disulfide compound containing reactive functional groups (e.g., carboxyl, hydroxyl, amine, etc.) can be reacted with the polyarylene sulfide. Functionalization of the polyarylene sulfide can further provide sites for bonding between any optional impact modifiers and the polyarylene sulfide, which can improve distribution of the impact modifier throughout the polyarylene sulfide and prevent phase separation. The disulfide compound may undergo a chain scission reaction with the polyarylene sulfide during melt processing to lower its overall melt viscosity. When employed, disulfide compounds typically constitute from about 0.01 wt. % to about 3 wt. %, in some embodiments from about 0.02 wt. % to about 1 wt. %, and in some embodiments, from about 0.05 to about 0.5 wt. % of the polymer composition. The ratio of the amount of the polyarylene sulfide to the amount of the disulfide compound may likewise be from about 1000:1 to about 10:1, from about 500:1 to about 20:1, or from about 400:1 to about 30:1. Suitable disulfide compounds are typically those having the following formula: R³—S—S—R⁴

wherein R³ and R⁴ may be the same or different and are hydrocarbon groups that independently include from 1 to about 20 carbons. For instance, R³ and R⁴ may be an alkyl, cycloalkyl, aryl, or heterocyclic group. In certain embodiments, R³ and R⁴ are generally nonreactive functionalities, such as phenyl, naphthyl, ethyl, methyl, propyl, etc. Examples of such compounds include diphenyl disulfide, naphthyl disulfide, dimethyl disulfide, diethyl disulfide, and dipropyl disulfide. R³ and R⁴ may also include reactive functionality at terminal end(s) of the disulfide compound. For example, at least one of R³ and R⁴ may include a terminal carboxyl group, hydroxyl group, a substituted or non-substituted amino group, a nitro group, or the like. Examples of compounds may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid (or 2,2′-dithiobenzoic acid), dithioglycolic acid, a,a′-dithiodilactic acid, P,P′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole), 2-(4′-morpholinodithio)benzothiazole, etc., as well as mixtures thereof.

B. Impact Modifier

Impact modifiers may also be employed within the polymer composition. When employed, such impact modifier(s) typically constitute from 5 to about 50 parts, in some embodiments from about 10 to about 45 parts, and in some embodiments, from about 20 to about 40 parts by weight per 100 parts by weight of the polyarylene sulfide(s). For example, the impact modifiers may constitute from about 1 wt. % to about 40 wt. %, in some embodiments from about 5 wt. % to about 35 wt. %, and in some embodiments, from about 15 wt. % to about 30 wt. % of the polymer composition.

Examples of suitable impact modifiers may include, for instance, polyepoxides, polyurethanes, polybutadiene, acrylonitrile-butadiene-styrene, polyamides, block copolymers (e.g., polyether-polyamide block copolymers), etc., as well as mixtures thereof. In one embodiment, an olefin copolymer is employed that is “epoxy-functionalized” in that it contains, on average, two or more epoxy functional groups per molecule. The copolymer generally contains an olefinic monomeric unit that is derived from one or more α-olefins. Examples of such monomers include, for instance, linear and/or branched α-olefins having from 2 to 20 carbon atoms and typically from 2 to 8 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin monomers are ethylene and propylene. The copolymer may also contain an epoxy-functional monomeric unit. One example of such a unit is an epoxy-functional (meth)acrylic monomeric component. As used herein, the term “(meth)acrylic” includes acrylic and methacrylic monomers, as well as salts or esters thereof, such as acrylate and methacrylate monomers. For example, suitable epoxy-functional (meth)acrylic monomers may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate. Other suitable monomers may also be employed to help achieve the desired molecular weight.

Of course, the copolymer may also contain other monomeric units as is known in the art. For example, another suitable monomer may include a (meth)acrylic monomer that is not epoxy-functional. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In one particular embodiment, for example, the copolymer may be a terpolymer formed from an epoxy-functional (meth)acrylic monomeric component, α-olefin monomeric component, and non-epoxy functional (meth)acrylic monomeric component. The copolymer may, for instance, be poly(ethylene-co-butylacrylate-co-glycidyl methacrylate), which has the following structure:

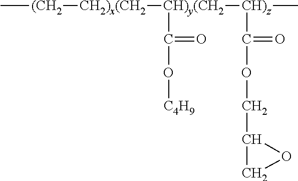

wherein, x, y, and z are 1 or greater.

The relative portion of the monomeric component(s) may be selected to achieve a balance between epoxy-reactivity and melt flow rate. More particularly, high epoxy monomer contents can result in good reactivity with the matrix polymer, but too high of a content may reduce the melt flow rate to such an extent that the copolymer adversely impacts the melt strength of the polymer blend. Thus, in most embodiments, the epoxy-functional (meth)acrylic monomer(s) constitute from about 1 wt. % to about 20 wt. %, in some embodiments from about 2 wt. % to about 15 wt. %, and in some embodiments, from about 3 wt. % to about 10 wt. % of the copolymer. The α-olefin monomer(s) may likewise constitute from about 55 wt. % to about 95 wt. %, in some embodiments from about 60 wt. % to about 90 wt. %, and in some embodiments, from about 65 wt. % to about 85 wt. % of the copolymer. When employed, other monomeric components (e.g., non-epoxy functional (meth)acrylic monomers) may constitute from about 5 wt. % to about 35 wt. %, in some embodiments from about 8 wt. % to about 30 wt. %, and in some embodiments, from about 10 wt. % to about 25 wt. % of the copolymer. The resulting melt flow rate is typically from about 1 to about 30 grams per 10 minutes (“g/10 min”), in some embodiments from about 2 to about 20 g/10 min, and in some embodiments, from about 3 to about 15 g/10 min, as determined in accordance with ASTM D1238-13 at a load of 2.16 kg and temperature of 190° C.

If desired, additional impact modifiers may also be employed in combination with the epoxy-functional impact modifier. For example, the additional impact modifier may include a block copolymer in which at least one phase is made of a material that is hard at room temperature but fluid upon heating and another phase is a softer material that is rubber-like at room temperature. For instance, the block copolymer may have an A-B or A-B-A block copolymer repeating structure, where A represents hard segments and B is a soft segment. Non-limiting examples of impact modifiers having an A-B repeating structure include polyamide/polyether, polysulfone/polydimethylsiloxane, polyurethane/polyester, polyurethane/polyether, polyester/polyether, polycarbonate/polydimethylsiloxane, and polycarbonate/polyether. Triblock copolymers may likewise contain polystyrene as the hard segment and either polybutadiene, polyisoprene, or polyethylene-co-butylene as the soft segment. Similarly, styrene butadiene repeating co-polymers may be employed, as well as polystyrene/polyisoprene repeating polymers. In one particular embodiment, the block copolymer may have alternating blocks of polyamide and polyether. Such materials are commercially available, for example from Atofina under the PEBAX™ trade name. The polyamide blocks may be derived from a copolymer of a diacid component and a diamine component or may be prepared by homopolymerization of a cyclic lactam. The polyether block may be derived from homo- or copolymers of cyclic ethers such as ethylene oxide, propylene oxide, and tetrahydrofuran.

C. Crosslinking System

If desired, a crosslinking system may also be employed in combination with any optional impact modifier(s) to help further improve the strength and flexibility of the composition under a variety of different conditions. In such circumstances, a crosslinked product may be formed from a crosslinkable polymer composition that contains the polyarylene sulfide(s), impact modifier(s), and crosslinking system. When employed, such a crosslinking system, which may contain one or more crosslinking agents, typically constitutes from about 0.1 to about 15 parts, in some embodiments from about 0.2 to about 10 parts, and in some embodiments, from about 0.5 to about 5 parts per 100 parts of the polyarylene sulfide(s), as well as from about 0.05 wt. % to about 15 wt. %, in some embodiments from about 0.1 wt. % to about 10 wt. %, and in some embodiments, from about 0.2 wt. % to about 5 wt. % of the polymer composition. Through the use of such a crosslinking system, the compatibility and distribution of the polyarylene sulfide and impact modifier can be significantly improved. For example, the impact modifier is capable of being dispersed within the polymer composition in the form of discrete domains of a nano-scale size. For example, the domains may have an average cross-sectional dimension of from about 1 to about 1000 nanometers, in some embodiments from about 5 to about 800 nanometers, in some embodiments from about 10 to about 500 nanometers. The domains may have a variety of different shapes, such as elliptical, spherical, cylindrical, plate-like, tubular, etc. Such improved dispersion can result in either better mechanical properties or allow for equivalent mechanical properties to be achieved at lower amounts of impact modifier.

Any of a variety of different crosslinking agents may generally be employed within the crosslinking system. In one embodiment, for instance, the crosslinking system may include a metal carboxylate. Without intending to be limited by theory, it is believed that the metal atom in the carboxylate can act as a Lewis acid that accepts electrons from the oxygen atom located in a functional group (e.g., epoxy functional group) of the impact modifier. Once it reacts with the carboxylate, the functional group can become activated and can be readily attacked at either carbon atom in the three-membered ring via nucleophilic substitution, thereby resulting in crosslinking between the chains of the impact modifier. The metal carboxylate is typically a metal salt of a fatty acid. The metal cation employed in the salt may vary, but is typically a divalent metal, such as calcium, magnesium, lead, barium, strontium, zinc, iron, cadmium, nickel, copper, tin, etc., as well as mixtures thereof. Zinc is particularly suitable. The fatty acid may generally be any saturated or unsaturated acid having a carbon chain length of from about 8 to 22 carbon atoms, and in some embodiments, from about 10 to about 18 carbon atoms. If desired, the acid may be substituted. Suitable fatty acids may include, for instance, lauric acid, myristic acid, behenic acid, oleic acid, palmitic acid, stearic acid, ricinoleic acid, capric acid, neodecanoic acid, hydrogenated tallow fatty acid, hydroxy stearic acid, the fatty acids of hydrogenated castor oil, erucic acid, coconut oil fatty acid, etc., as well as mixtures thereof. Metal carboxylates typically constitute from about 0.05 wt. % to about 5 wt. %, in some embodiments from about 0.1 wt. % to about 2 wt. %, and in some embodiments, from about 0.2 wt. % to about 1 wt. % of the polymer composition.

The crosslinking system may also employ a crosslinking agent that is “multi-functional” to the extent that it contains at least two reactive, functional groups. Such a multi-functional crosslinking reagent may serve as a weak nucleophile, which can react with activated functional groups on the impact modifier (e.g., epoxy functional groups). The multi-functional nature of such molecules enables them to bridge two functional groups on the impact modifier, effectively serving as a curing agent. The multi-functional crosslinking agents generally include two or more reactively functional terminal moieties linked by a bond or a non-polymeric (non-repeating) linking component. By way of example, the crosslinking agent can include a di-epoxide, poly-functional epoxide, diisocyanate, polyisocyanate, polyhydric alcohol, water-soluble carbodiimide, diamine, diol, diaminoalkane, multi-functional carboxylic acid, diacid halide, etc. Multi-functional carboxylic acids and amines are particularly suitable. Specific examples of multi-functional carboxylic acid crosslinking agents can include, without limitation, isophthalic acid, terephthalic acid, phthalic acid, 1,2-di(p-carboxyphenyl)ethane, 4,4′-dicarboxydiphenyl ether, 4,4′-bisbenzoic acid, 1,4- or 1,5-naphthalene dicarboxylic acids, decahydronaphthalene dicarboxylic acids, norbornene dicarboxylic acids, bicyclooctane dicarboxylic acids, 1,4-cyclohexanedicarboxylic acid (both cis and trans), 1,4-hexylenedicarboxylic acid, adipic acid, azelaic acid, dicarboxyl dodecanoic acid, succinic acid, maleic acid, glutaric acid, suberic acid, azelaic acid and sebacic acid. The corresponding dicarboxylic acid derivatives, such as carboxylic acid diesters having from 1 to 4 carbon atoms in the alcohol radical, carboxylic acid anhydrides or carboxylic acid halides may also be utilized. In certain embodiments, aromatic dicarboxylic acids are particularly suitable, such as isophthalic acid or terephthalic acid.

When employed, multi-functional crosslinking agents typically constitute from about 50 wt. % to about 95 wt. %, in some embodiments from about 60 wt. % to about 90 wt. %, and in some embodiments, from about 70 wt. % to about 85 wt. % of the crosslinking system, while the metal carboxylates typically constitute from about 5 wt. % to about 50 wt. %, in some embodiments from about 10 wt. % to about 40 wt. %, and in some embodiments, from about 15 wt. % to about 30 wt. % of the crosslinking system. For example, the multi-functional crosslinking agents may constitute from about 0.1 wt. % to about 10 wt. %, in some embodiments from about 0.2 wt. % to about 5 wt. %, and in some embodiments, from about 0.5 wt. % to about 3 wt. % of the polymer composition. Of course, in certain embodiments, the composition may be generally free of multi-functional crosslinking agents, or the crosslinking system may be generally free of metal carboxylates.

D. Other Components

In addition to the components noted above, the polymer composition may also contain a variety of other different components to help improve its overall properties. In one embodiment, for example, the polymer composition may contain a heat stabilizer. By way of example, the heat stabilizer can be a phosphite stabilizer, such as an organic phosphite. For example, suitable phosphite stabilizers include monophosphites and diphosphites, wherein the diphosphite has a molecular configuration that inhibits the absorption of moisture and/or has a relatively high Spiro isomer content. For instance, a diphosphite stabilizer may be selected that has a spiro isomer content of greater than 90%, such as greater than 95%, such as greater than 98%. Specific examples of such diphosphite stabilizers include, for instance, bis(2,4-dicumylphenyl)pentaerythritol diphosphite, bis(2,4-di-t-butylphenyl)pentaerythritol diphosphite, distearyl pentaerythritol diphosphite, mixtures thereof, etc. When employed, heat stabilizers typically constitute from about 0.1 wt. % to about 3 wt. %, and in some embodiments, from about 0.2 wt. % to about 2 wt. % of the composition.

Inorganic fibers may also be employed, such as in an amount from about wt. % to about 50 wt. %, in some embodiments from about 2 wt. % to about 40 wt. %, and in some embodiments, from about 5 wt. % to about 30 wt. % of the polymer composition. Any of a variety of different types of inorganic fibers may generally be employed, such as those that are derived from glass; silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Glass fibers are particularly suitable for use in the present invention, such as those formed from E-glass, A-glass, C-glass, D-glass, AR-glass, R-glass, S1-glass, S2-glass, etc., as well as mixtures thereof. If desired, the glass fibers may be provided with a sizing agent or other coating as is known in the art.

The inorganic fibers may have any desired cross-sectional shape, such as circular, flat, etc. In certain embodiments, it may be desirable to employ fibers having a relatively flat cross-sectional dimension in that they have an aspect ratio (i.e., cross-sectional width divided by cross-sectional thickness) of from about 1.5 to about 10, in some embodiments from about 2 to about 8, and in some embodiments, from about 3 to about 5. When such flat fibers are employed in a certain concentration, they may further improve the mechanical properties of the molded part without having a substantial adverse impact on the melt viscosity of the polymer composition. The inorganic fibers may, for example, have a nominal width of from about 1 to about 50 micrometers, in some embodiments from about 5 to about 50 micrometers, and in some embodiments, from about 10 to about 35 micrometers. The fibers may also have a nominal thickness of from about 0.5 to about 30 micrometers, in some embodiments from about 1 to about 20 micrometers, and in some embodiments, from about 3 to about 15 micrometers. Further, the inorganic fibers may have a narrow size distribution. That is, at least about 60% by volume of the fibers, in some embodiments at least about 70% by volume of the fibers, and in some embodiments, at least about 80% by volume of the fibers may have a width and/or thickness within the ranges noted above. In the molded part, the volume average length of the glass fibers may be from about 10 to about 500 micrometers, in some embodiments from about 100 to about 400 micrometers, and in some embodiments, from about 150 to about 350 micrometers.

An organosilane compound may also be employed in certain embodiments. Such organosilane compounds typically constitute from about 0.01 wt. % to about 3 wt. %, in some embodiments from about 0.02 wt. % to about 1 wt. %, and in some embodiments, from about 0.05 to about 0.5 wt. % of the polymer composition. The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

R⁵—Si—(R⁶)₃,

wherein,

R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth;

R⁶ is an alkoxy group of from 1 to 10 carbon atoms, such as methoxy, ethoxy, propoxy, and so forth.

Some representative examples of organosilane compounds that may be included in the mixture include mercaptopropyl trimethyoxysilane, mercaptopropyl triethoxysilane, aminopropyl triethoxysilane, aminoethyl triethoxysilane, aminopropyl trimethoxysilane, aminoethyl trimethoxysilane, ethylene trimethoxysilane, ethylene triethoxysilane, ethyne trimethoxysilane, ethyne triethoxysilane, aminoethylaminopropyltrimethoxysilane, 3-aminopropyl triethoxysilane, 3-aminopropyl trimethoxysilane, 3-aminopropyl methyl dimethoxysilane or 3-aminopropyl methyl diethoxysilane, N-(2-aminoethyl)-3-aminopropyl trimethoxysilane, N-methyl-3-aminopropyl trimethoxysilane, N-phenyl-3-aminopropyl trimethoxysilane, bis(3-aminopropyl) tetramethoxysilane, bis(3-aminopropyl) tetraethoxy disiloxane, γ-aminopropyltrimethoxysilane, γ-aminopropyltriethoxysilane, γ-aminopropylmethyldimethoxysilane, γ-aminopropylmethyldiethoxysilane, N—(β-aminoethyl)-γ-aminopropyltrimethoxysilane, N-phenyl-γ-aminopropyltrimethoxysilane, γ-diallylaminopropyltrimethoxysilane, γ-diallylaminopropyltrimethoxysilane, etc., as well as combinations thereof. Particularly suitable organosilane compounds are 3-aminopropyltriethoxysilane and 3-mercaptopropyltrimethoxysilane.

If desired, a siloxane polymer may also be employed in the polymer composition. Without intending to be limited by theory, it is believed that the siloxane polymer can, among other things, improve the processing of the composition, such as by providing better mold filling, internal lubrication, mold release, etc. Further, it is also believed that the siloxane polymer is less likely to migrate or diffuse to the surface of the composition, which further minimizes the likelihood of phase separation and further assists in dampening impact energy. For instance, such siloxane polymers typically have a weight average molecular weight of about 100,000 grams per mole or more, in some embodiments about 200,000 grams per mole or more, and in some embodiments, from about 500,000 grams per mole to about 2,000,000 grams per mole. The siloxane polymer may also have a relatively high kinematic viscosity, such as about 10,000 centistokes or more, in some embodiments about 30,000 centistokes or more, and in some embodiments, from about 50,000 to about 500,000 centistokes.

Any of a variety of high molecular weight siloxane polymers may generally be employed in the polymer composition. In certain embodiments, for example, the siloxane polymer may be an “MQ” resin, which is a macromolecular polymer formed primarily from R₃SiO_{1/2} and SiO_{4/2} units (the M and Q units, respectively), wherein R is a functional or nonfunctional organic group. Suitable organofunctional groups (“R”) may include, for instance, alkyl (e.g., methyl, ethyl, propyl, butyl, etc.), aryl (e.g., phenyl), cycloalkyl (e.g., cyclopentyl), arylenyl, alkenyl, cycloalkenyl (e.g., cyclohexenyl), alkoxy (e.g., methoxy), etc., as well as combinations thereof. Such resins are generally prepared by chemically linking (copolymerizing) MQ resin molecules having a low weight average molecular weight (such as less than 100,000 grams per mole) with polysiloxane linkers. In one particular embodiment, for instance, the resin may be formed by copolymerizing a low molecular weight MQ solid resin (A) with a substantially linear polydiorganosiloxane linker (B), such as described in U.S. Pat. No. 6,072,012 to Juen, et al. The resin (A) may, for instance, have M and Q siloxy units having the following general formula:

R¹ₐR²_{b}R³_{c}SiO_{(4-a-b-c)}/₂

wherein,
R¹ is a hydroxyl group;
R² is a monovalent hydrocarbon group having at least one unsaturated carbon-carbon bond (i.e., vinyl) that is capable of addition reaction with a silicon-bonded hydrogen atom;
each R³ is independently selected from the group consisting of alkyl, aryl and arylalkyl groups;
a is a number from 0 to 1, and in some embodiments, from 0 to 0.2;
b is number from 0 to 3, and in some embodiments, from 0 to 1.5; and
c is a number greater than or equal to 0.

The substantially linear polydiorganosiloxane linker (B) may likewise have the following general formula:

(R⁴₍₃₋ₚ₎R⁵ₚSiO_{1/2})(R⁴SiO_{2/2})ₓ((R⁴R⁵SiO_{2/2})(R⁴R⁵SiO_{2/2})ₓ)_{y}(R⁴₍₃₋ₚ₎R⁵ₚSiO_{1/2})

wherein,
each R⁴ is a monovalent group independently selected from the group consisting of alkyl, aryl, and arylalkyl groups;
each R⁵ is a monovalent group independently selected from the group consisting of hydrogen, hydroxyl, alkoxy, oximo, alkyloximo, and aryloximo groups, wherein at least two R⁵ groups are typically present in each molecule and bonded to different silicon atoms;
p is 0, 1, 2, or 3;
x ranges from 0 to 200, and in some embodiments, from 0 to 100; and
y ranges from 0 to 200, and in some embodiments, from 0 to 100.

The high molecular siloxane polymers typically constitute from about 0.05 wt. % to about 5 wt. %, in some embodiments from about 0.1 wt. % to about 3 wt. %, and in some embodiments, from about 0.5 to about 2 wt. % of the polymer composition.

In certain embodiments, the siloxane polymer may be provided in the form of a masterbatch that includes a carrier resin. The carrier resin may, for instance, constitute from about 0.05 wt. % to about 5 wt. %, in some embodiments from about 0.1 wt. % to about 3 wt. %, and in some embodiments, from about 0.5 to about 2 wt. % of the polymer composition. Any of a variety of carrier resins may be employed, such as polyolefins (ethylene polymer, propylene polymers, etc.), polyamides, etc. In one embodiment, for example, the carrier resin is an ethylene polymer. The ethylene polymer may be a copolymer of ethylene and an α-olefin, such as a C₃-C₂₀α-olefin or C₃-C₁₂α-olefin. Suitable α-olefins may be linear or branched (e.g., one or more C₁-C₃ alkyl branches, or an aryl group). Specific examples include 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin comonomers are 1-butene, 1-hexene and 1-octene. The ethylene content of such copolymers may be from about 60 mole % to about 99 mole %, in some embodiments from about 80 mole % to about 98.5 mole %, and in some embodiments, from about 87 mole % to about 97.5 mole %. The α-olefin content may likewise range from about 1 mole % to about 40 mole %, in some embodiments from about 1.5 mole % to about 15 mole %, and in some embodiments, from about 2.5 mole % to about 13 mole %. The density of the ethylene polymer may vary depending on the type of polymer employed, but generally ranges from about 0.85 to about 0.96 grams per cubic centimeter (g/cm³). Polyethylene “plastomers”, for instance, may have a density in the range of from about 0.85 to about 0.91 g/cm³. Likewise, “linear low density polyethylene” (LLDPE) may have a density in the range of from about 0.91 to about 0.940 g/cm³; “low density polyethylene” (LDPE) may have a density in the range of from about 0.910 to about 0.940 g/cm³; and “high density polyethylene” (HDPE) may have density in the range of from about 0.940 to about 0.960 g/cm³, such as determined in accordance with ASTM D792. Some non-limiting examples of high molecular weight siloxane polymer masterbatches that may be employed include, for instance, those available from Dow Corning under the trade designations MB50-001, MB50-002, MB50-313, MB50-314 and MB50-321.

If desired, a nucleating agent may also be employed to further enhance the crystallization properties of the composition. One example of such a nucleating agent is an inorganic crystalline compound, such as boron-containing compounds (e.g., boron nitride, sodium tetraborate, potassium tetraborate, calcium tetraborate, etc.), alkaline earth metal carbonates (e.g., calcium magnesium carbonate), oxides (e.g., titanium oxide, aluminum oxide, magnesium oxide, zinc oxide, antimony trioxide, etc.), silicates (e.g., talc, sodium-aluminum silicate, calcium silicate, magnesium silicate, etc.), salts of alkaline earth metals (e.g., calcium carbonate, calcium sulfate, etc.), and so forth. Boron nitride (BN) has been found to be particularly beneficial when employed in the polymer composition of the present invention. Boron nitride exists in a variety of different crystalline forms (e.g., h-BN-hexagonal, c-BN-cubic or spharlerite, and w-BN-wurtzite), any of which can generally be employed in the present invention.The hexagonal crystalline form is particularly suitable due to its stability and softness.

Still other components that can be included in the composition may include, for instance, particulate fillers (e.g., talc, mica, etc.), antimicrobials, pigments (e.g., black pigments), antioxidants, stabilizers, surfactants, waxes, flow promoters, solid solvents, flame retardants, and other materials added to enhance properties and processability.

### II. Melt Processinq

The manner in which the polyarylene sulfide and other optional additives are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 100° C. to about 500° C., and in some embodiments, from about 150° C. to about 300° C. A variety of different techniques may be employed in the present invention to react the polyarylene sulfide and impact modifier in the presence of the crosslinking system. Likewise, the apparent shear rate during melt processing may range from about 100 seconds-¹ to about 10,000 seconds-¹, and in some embodiments, from about 500 seconds-¹ to about 1,500 seconds-¹. Of course, other variables, such as the residence time during melt processing, which is inversely proportional to throughput rate, may also be controlled to achieve the desired degree of homogeneity.

If desired, one or more distributive and/or dispersive mixing elements may be employed within the mixing section of the melt processing unit. Suitable distributive mixers may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers. The speed of the screw can also be controlled to improve the characteristics of the composition. For instance, the screw speed can be about 400 rpm or less, in one embodiment, such as between about 200 rpm and about 350 rpm, or between about 225 rpm and about 325 rpm. In one embodiment, the compounding conditions can be balanced so as to provide a polymer composition that exhibits improved properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally, it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs. In one embodiment, a system can include a medium to aggressive screw design with relatively mild screw speeds (e.g., between about 200 rpm and about 300 rpm).

The crystallization temperature of the resulting polymer composition (prior to being formed into a shaped part) may be about 250° C. or less, in some embodiments from about 100° C. to about 245° C., and in some embodiments, from about 150° C. to about 240° C. The melting temperature of the polymer composition may also range from about 250° C. to about 320° C., and in some embodiments, from about 260° C. to about 300° C. The melting and crystallization temperatures may be determined as is well known in the art using differential scanning calorimetry in accordance with ISO Test No. 11357-3:2018.

### III. Electrolyzer Fluidic Member

The polymer composition may be shaped into the form of an electrolyzer fluidic member using any of a variety of techniques as is known in the art. In certain embodiments, for instance, a shaped part may be formed by a molding technique, such as injection molding, compression molding, nanomolding, overmolding, blow molding, thermoforming, etc.; melt extrusion techniques, such as tubular trapped bubble film processes, flat or tube cast film processes, slit die flat cast film processes, etc.; and so forth. For example, blow molding generally involves the use of a pressurized gas that is forced against the interior surface of a mold member. For instance, the polymer composition may be heated and extruded into a parison, which can be received by a mold that includes separate portions that together combine to form a three-dimensional mold cavity. More particularly, after the parison reaches a desired length, a clamping mechanism can move the parison into a position so that it interacts with the mold. The mold is then closed and a pressurized gas (e.g., inert gas) is provided to apply sufficient pressure against the interior surface of the parison such that it conforms to the shape of the mold cavity. After such a blow molding operation, cool air may be injected into the molded part for solidifying the polymer composition prior to its removal.

In embodiments, the electrolyzer fluidic member can be an elongated member such as a pipe, tube, or hose that generally defines a hollow interior through which a fluid is capable of passing, such as a gas (e.g., product gas, etc.), vapor, or liquid (e.g., water (e.g., deionized water), liquid electrolyte, etc.), or any combination thereof. For example, the fluidic member may define a passageway that extends between an inlet through which a fluid may enter the member and an outlet through which the fluid may exit. The member may contain a single inlet and/or single outlet. In other cases, however, the member may define multiple inlets and/or outlets through which the fluid may enter and/or exit the member, respectively.

In other embodiments, a fluidic member can be a connector, fitting, etc., for instance as may be utilized to connect hoses, tubes, or pipes to one another and/or to another component of the electrolyzer system.

When used in conveying fluid to or from the electrolyzer, for instance, a fluidic member may contain multiple outlets through which a fluid (e.g., a fuel in the form of water or steam) is able to exit to contact one or both sides of the electrochemical reactor cell or through which a product (e.g., oxygen, hydrogen, syngas) is able to exit the electrochemical reactor cell. If desired, such outlets may be provided by branched portions of a member that extend from a central portion or by multiple members connected to one another. The fluidic member may have a variety of shapes and may extend in a single direction or in multiple directions so that it includes multiple angular displacements. The angular displacement(s) may be at a relatively high angle, such as from about 60° to about 120° , in some embodiments from about 70° to about 110° , and in some embodiments, from about 80° to about 100° (e.g., 90° ). A fluidic member may likewise contain one or more curved sections that define the angular displacement(s) optionally in conjunction with one or more linear sections located adjacent to angular displacement(s). The curved sections may lie in a single plane or may lie in multiple planes (based on the axis of the fluidic member such that the axis lies in each plane).

Regardless of its particular configuration, the fluidic member may have a variety of shapes and/or sizes. For instance, at least a portion of the fluidic member, and optionally the entire fluidic member, may have a cross-sectional shape that is circular, elliptical, square, triangular, rectangular, or irregular in nature. The fluidic member may also be of any desired size with no particular limit on inside or outside diameter, wall thickness, etc. In one embodiment, for instance, at least a portion of the fluidic member, and optionally the entire fluidic member, has an external dimension (e.g., diameter) of from about 1 to about 50 millimeters, in some embodiments from about 2 to about 40 millimeters, and in some embodiments, from about 3 to about 30 millimeters. The thickness of a wall of a fluidic member may likewise range from about 0.5 to about 45 millimeters, in some embodiments from about 1 to about 35 millimeters, and in some embodiments, from about 2 to about 25 millimeters. In this regard, the wall thickness of the fluidic member is typically from about 0.5 to about 5 millimeters. The fluidic member may be formed from a single layer containing the polymer composition of the present invention. In other embodiments, the fluidic member may contain multiple layers in which one or more of such layers contain the polymer composition of the present invention. In one embodiment, for instance, a multi-layered hose may contain an outer layer that defines the outer diameter of the hose, an inner layer that defines the inner diameter of the hose, and one or more optional intermediate layers that are positioned between the outer and inner layers. The polymer composition of the present invention may be employed in the inner, outer, and/or intermediate layers. In one embodiment, for instance, the polymer composition is used to form the outer layer. In another embodiment, the polymer composition is used to form the inner layer. The high strength characteristics of the thermoplastic composition combined with the excellent barrier properties and good flexibility make the thermoplastic composition suitable for use in forming outer layers, inner layers, and/or intermediate layers of a multi-layer fluidic member. For instance, the excellent barrier properties of the thermoplastic composition combined with the flexibility and chemical resistance properties of the thermoplastic composition make it suitable for use in forming an inner layer of a multi-layer fluidic member, e.g., a hose, in one embodiment.

Multi-layer fluidic members can include two, three or more layers, and one or more layers of the member can include the polymer composition of the present invention. Multi-layer fluidic members can have a variety of cross-sectional shapes and sizes as well as any suitable length configuration, as discussed above. In general, each layer of a multi-layer fluidic member can have a wall thickness of from about 0.5 to about 5 millimeters.

If desired, other types of polymeric materials may be used to form other layers of the fluidic member (e.g., an inner or outer layer), such as an elastomer (e.g., silicone, natural rubber, acrylonitrile-butadiene rubber, styrene elastomer, etc.), polyolefin, polyamide, fluoropolymer, polyvinyl chloride, etc. By way of example, one or more layers of a multi-layer hose can be formed of polyamides from the group of homopolyamides, co-polyamides, their blends, or mixtures which each other or with other polymers. Thermoplastic elastomers can be utilized in forming one or more layers of a multi-layer fluidic member including, without limitation, polyamide thermoplastic elastomers, polyester thermoplastic elastomers, polyolefin thermoplastic elastomers, and styrene thermoplastic elastomers. Exemplary materials can include, without limitation, ethylene-propylene-diene terpolymer rubber, ethylene-propylene rubber, chlorosulfonated polyethylene rubber, a blend of acrylonitrile-butadiene rubber and polyvinyl chloride, a blend of acrylonitrile-butadiene rubber and ethylene-propylene-diene terpolymer rubber, and chlorinated polyethylene rubber. A multi-layer fluidic member may further contain one or more intermediary adhesive layers formed from adhesive materials such as, for example, polyester polyurethanes, polyether polyurethanes, polyester elastomers, polyether elastomers, polyamides, polyether polyamides, polyether polyimides, functionalized polyolefins, and the like.

Any known process can be employed without any particular limitation for manufacturing a multi-layer fluidic member. For instance, layers forming a multi-layer hose can be formed by an extrusion process or one or more other conventional processes, such as, for example, co-extrusion, dry lamination, sandwich lamination, coextrusion coating, and so forth. Adjacent layers can be formed simultaneously by a co-extrusion method, i.e., extruding the molten materials for those layers concentrically and simultaneously, and causing them to adhere to each other. Co-extrusion may be performed by using any known apparatus including co-extrusion heads. In general, co-extrusion can be used in forming a multi-layer fluidic member having from two to about six layers.

Co-extrusion is not a requirement of an extrusion formation process, however, and in other embodiments an outer layer of a fluidic member can be formed on a pre-formed layer(s). For instance, an outer layer can be formed by extrusion about one or more pre-formed inner layers (inner wall layer, or inner and intermediate wall layers), fluidic member any other method can also be employed.

A multi-layer fluidic member also be formed through utilization of a blow molding process to form one or more layers of a member. For instance, a blow molding process can be utilized to form an inner layer on a pre-formed layer, which can be formed according to a blow molding process as well or according to a different formation technique, e.g., an extrusion process.

### IV. Electrolyzer System

The electrolyzer fluidic member may be employed in a variety of different types of electrolyzer systems as is known in the art. Typically, the electrolyzer system contains an electrochemical reactor cell, such as a polymer electrolyte membrane (PEM) electrolyzer cell, an alkaline electrolyzer cell, or a solid oxide electrolyzer cell (SOEC). Moreover, a PEM electrolyzer system can include a proton exchange PEM or an anion exchange PEM. For instance, in some embodiments an electrolyzer system can encompass a proton exchange PEM as in a proton exchange electrolyzer or an anion exchange PEM as in an anion exchange electrolyzer.

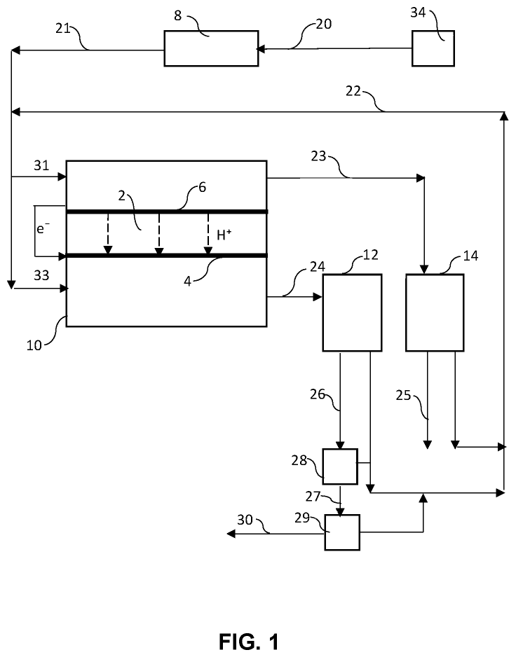

Referring to FIG. 1, for instance, one embodiment of a proton exchange PEM electrolyzer cell 10 is shown that contains a cathode 4 and an anode 6 separated by a PEM 2. In the illustrated embodiment, water can be fed to both sides of the electrolyzer cell 10 via a water feed hose 33 to the cathode side of the cell and a water feed hose 31 to the anode side of the cell. In some embodiments, water may be fed only to the anode side of the cell as the cell fuel, though in general, water may be fed to both sides of the cell in order to maintain hydration of the PEM. An oxygen discharge hose 23 and a hydrogen discharge hose 24 carry the electrolysis products from the cell 10.

Water can be provided to water feed hose 31 and water feed hose 33 via a common feed hose 21 as well as a recycle hose 22. In embodiments, water to the cell can be pretreated, such as by initial feed via hose 20 to a heat exchanger 8 to heat the feed water to a suitable temperature (e.g., about 80° C.). The water feed hoses 20, 21, 22, 31, 33 can be in communication with valves, pumps, sensors, etc. by use of connectors, fittings, etc. as known in the art. As such, a single feed line may be composed of several sections of hose in conjunction with such system components. The discharge hose 23 and the discharge hose 24 can carry the oxygen and hydrogen products to additional system components such as separators 12, 14, demisters 28 and dryers 29. Such components can be in fluid communication with one another via additional hoses 26, 27, as well as connectors, fittings, etc. Separated hydrogen and oxygen product of the cell 10 can be delivered via product hoses 25, 30. For instance, hydrogen product can be delivered directly to a system for utilization, e.g., to a fuel cell as a fuel, to a storage facility, or to a secondary system for further processing, e.g., chemical formation. Notably, the hoses 20, 21, 22, 23, 24, 25, 26, 27, 30, 31, 33 as well as other components such as connectors and fittings between hoses as well as between hoses and other system components may be formed in accordance with the present invention.

To operate the PEM electrolyzer cell 10, a water pump 34 is operated to introduce water via feed hose 20 into any preprocessing procedures, e.g., heating via heat exchanger 8, and then into the anode side of the electrochemical cell 10 via the water feed hoses 21, 31 and into the cathode side of the electrochemical cell via feed hoses 21, 33. As stated, the water can be fed to both sides of the cell in order to provide the PEM with moisture high enough to allow the performance of the cell 10 as well as into the anode side of the cell as the fuel for the cell 10.

At the anode 6, water is reacted according to the half reaction:

2 H₂O→4 H⁺+O₂+4 e⁻

The PEM 2 allows transport of the protons formed at the anode 6 to the cathode 4. Typical PEM materials include those available from DuPont Chemicals, Wilmington, Del., under the trade designation Nafion©, from Solvay, Brussels, Belgium, under the trade designation Aquivion®, and from Asahi Glass Co. Ltd., Tokyo, Japan, under the trade designation Flemion©. In embodiments, the membrane can include a copolymer of tetrafluoroethylene and FSO₂—CF₂CF₂CF₂CF₂—O—CF═CF₂.

At the cathode 4, the protons and electrons react according to the half reaction:

2H⁺+2e ⁻→H₂

The oxygen is then discharged from the cell 10 and anode 6 via hose 23 and the hydrogen is then discharged from the cell 10 and cathode 4 via hose 24. In general, the products can be discharged with water so far as water has been supplied in an amount great enough to purge them from the cell 10. Thereafter, the oxygen and hydrogen products can be separated from the water, e.g., via separators 12, 14, demister 28, dryer 29, to provide purified hydrogen product 30 and oxygen product 25. The separated water can be recycled to the cell 10 via recycle hose 22.

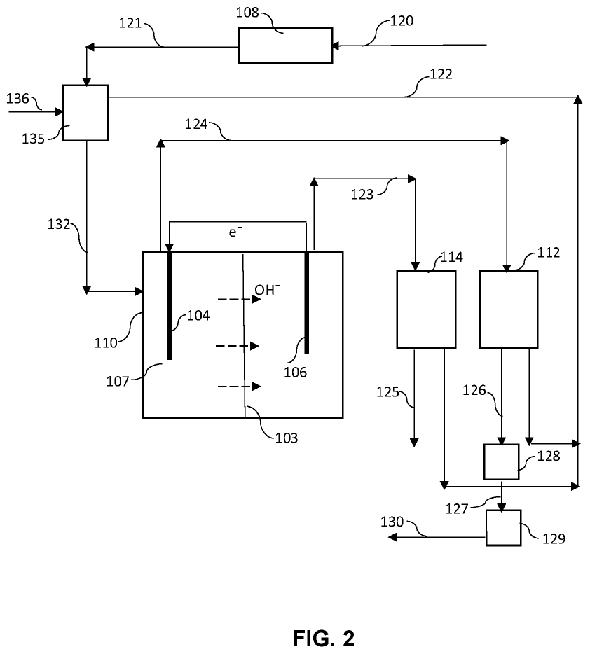

Referring to FIG. 2, one embodiment of an alkaline electrolyzer cell 110 is shown that contains a cathode 104 and an anode 106 held within a tank 107 that contains an aqueous alkaline electrolyte liquid. As shown, make-up electrolyzer liquid can be fed to the electrolyzer cell 110 via a water feed hose 132. An oxygen discharge hose 123 and a hydrogen discharge hose 124 carry the electrolysis products from the cell 110. In some embodiments, an electrolyzer cell 110 can include a diaphragm 103 separating the hydrogen and oxygen products from one another and allowing transport of hydroxide ions across the cell 110, e.g., a composite of zirconia and polysulfones available under the trade designation Zirfon©.

Feed water can be provided via hose 120 to a heat exchanger 108 where it can be preheated prior to being fed to a mixing tank 135 where it is combined with an alkaline electrolyte fed via hose 136 and optionally a recycle stream via hose 122. The feed hoses 120, 121, 122, 132, 136 can be in communication with valves, pumps, sensors, etc. by use of connectors, fittings, etc. as known in the art. As above, a single feed line may be composed of several sections of hose in conjunction with such system components. The discharge hose 123 and the discharge hose 124 can carry the oxygen and hydrogen products to additional system components such as separators 112, 114, demisters 128 and dryers 129. Such components can be in fluid communication with one another via additional hoses 126, 127 and associated connectors. Separated hydrogen and oxygen product of the cell 110 can be delivered via product hoses 125, 130. For instance, hydrogen product can be delivered directly to a system for utilization, e.g., to a fuel cell as a fuel, to a storage facility, or to a secondary system for further processing, e.g., chemical formation. Notably, the hoses 120, 121, 122, 123, 124, 125, 126, 127, 130, 132, 136 as well as related connectors, fittings or other fluidic members may be formed in accordance with the present invention.

To operate the alkaline electrochemical cell 110, water can be introduced via feed hose 120 into any preprocessing procedures, e.g., heating via heat exchanger 108, and then into the mixing tank 135 via hose 121 where it can be combined with recycle stream via hose 122 as well with make-up alkaline electrolyte fed as needed via hose 136. Hose 132 can deliver water and any make-up alkaline electrolyte to the tank 107 of the electrochemical cell 110. The aqueous alkaline electrolyte liquid within the tank 107 can generally include an alkaline electrolyte in an amount so as to provide an aqueous alkaline solution at from about 5 M to 9 M concentration. Alkaline electrolytes of a system can include, without limitation, sodium hydroxide, potassium hydroxide, lithium hydroxide, etc.

At the cathode 104, water is reacted according to the half reaction:

2 H₂O+2 e⁻→H₂+2 OH⁻

The hydroxide ion thus formed at the cathode 104 is transported to the anode 106, where it reacts according to the half reaction:

2OH⁻→½+H₂O+2e⁻

The oxygen is then discharged from the cell 110 and anode 106 via hose 123 and the hydrogen is then discharged from the cell 110 and cathode 104 via hose 124. In some embodiments, the products can be discharged with an amount of the alkaline electrolyte solution. Thereafter, the oxygen and hydrogen products can be separated from the solution, e.g., via separators 112, 114, demister 128, dryer 129, to provide purified hydrogen product 130 and oxygen product 125. The separated alkaline solution can be recycled to the cell 110 via recycle hose 122 as discussed.

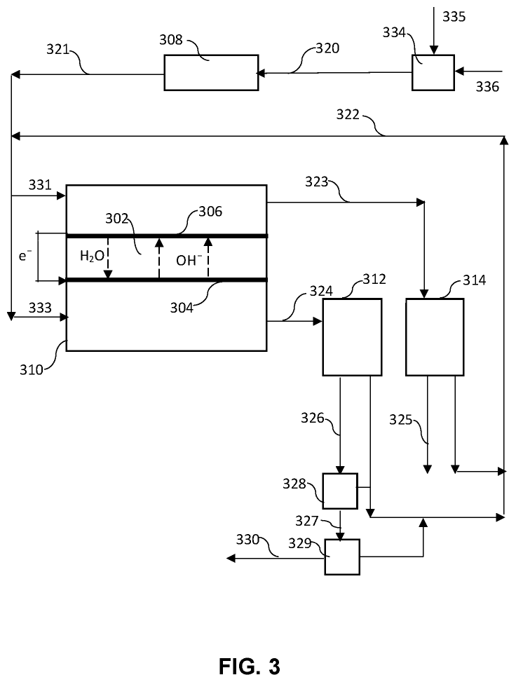

Electrolyzer fluidic members as described can be included in anion exchange PEM electrolyzer systems, which can be considered a hybrid of a proton exchange PEM electrolyzer and an alkaline electrolyzer. FIG. 3 presents one embodiment of an anion exchange PEM electrolyzer cell 310 that contains a cathode 304 and an anode 306 separated by an anion exchange PEM 302. In the illustrated embodiment, an alkaline water composition can be fed to the anode side of the electrolyzer cell 310 via a feed hose 331 and to the cathode side of the electrolyzer cell 310 via a feed hose 333. An oxygen discharge hose 323 and a hydrogen discharge hose 324 carry the electrolysis products from the cell 310.

The alkaline water feed can be provided to feed hose 331 and feed hose 333 via a feed hose 321 that can optionally couple with a recycle hose 322 via a suitable connector. In embodiments, feed to the cell can be pretreated, such as by initial combination of water fed via hose 336 with a suitable alkaline electrolyte (e.g., HCO₃⁻/CO₃²⁻, KOH, etc.) fed via hose 335 in fluidic communication with a mixer 334. The resulting alkaline feed can be fed via hose 320 to a heat exchanger 308 to heat the feed to a suitable temperature (e.g., about 80° C.). The feed hoses 320, 321, 322, 331, 333, 335, 336 can be in communication with valves, pumps, sensors, etc. via suitable connectors and fittings as known in the art. As such, a single feed line may be composed of several sections of hose in fluidic communication with such system components. The discharge hose 323 and the discharge hose 324 can carry the oxygen and hydrogen products to additional system components such as separators 312, 314, demisters 328 and dryers 329. Such components can be in fluid communication with one another via additional hoses 326, 327 in combination with other fluidic members, e.g., connectors and fittings. Separated hydrogen and oxygen product of the cell 310 can be delivered via product hoses 325, 330. Notably, the fluidic members of the system, e.g., feed hoses, recycle hoses, product hoses, processing hoses, connectors, fittings, etc. may be formed in accordance with the present invention.

To operate the anion exchange electrolyzer cell 310, a mixer 334 (which in some embodiments can be merely a connection between hoses including each hose end and a connector or fitting therebetween) is operated to combine water of feed hose 333 with electrolyzer of feed hose 335 to form alkaline feed that can then be carried via hose 320 into any preprocessing procedures, e.g., heating via heat exchanger 308, and then into the anode side of the electrochemical cell 310 via the feed hoses 321, 331 and to the cathode side of the electrochemical cell 310 via the feed hoses 321, 333.

The half reaction at the anode 306 is as follows:

4OH⁻→O₂+2H₂O+4e⁻

The half reaction at the cathode 304 is as follows:

4H₂O+4e⁻→+2H₂+4OH⁻

The anion exchange PEM 302 allows transport of the hydroxide anions formed at the cathode 304 to the anode 306. Typical anion exchange PEM materials include functionalized and quaternized poly(norbornenes) such as those sold by Xergy, Inc. under the trade name Xion™, radiation-grafted polyethylene based materials (e.g., poly (ethylene-co-tetrafluoroethylene), chloromethylated polysulfones, etc. The oxygen is then discharged from the cell 310 and anode 306 via hose 323 and the hydrogen is then discharged from the cell 310 and cathode 304 via hose 324. In general, the products can be discharged with alkaline water feed. Thereafter, the oxygen and hydrogen products can be separated from the feed, e.g., via separators 312, 314, demister 328, dryer 329, to provide purified hydrogen product 330 and oxygen product 325. The separated feed can be recycled to the cell 310 via recycle hose 322.

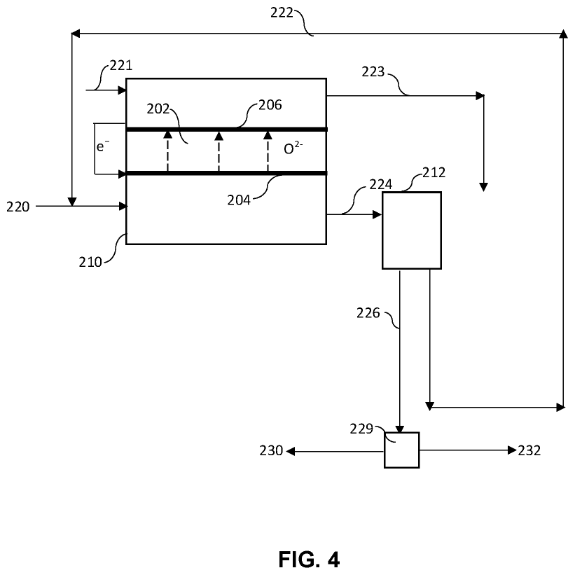

Fluidic members as disclosed herein can also be beneficially utilized in a solid oxide electrolyzer cell system. Referring to FIG. 4, one embodiment of an SOEC 210 is shown that includes a cathode 204 and an anode 206 separated by a solid oxide electrolyte 202. Fuel can be provided to the cathode side of the cell 210 via a hose 220. In some embodiments, the fuel can include water (generally in the form of steam) for water electrolysis. However, a SOEC system as described is not limited to water electrolysis, and disclosed fluidic members can beneficially be utilized in SOEC systems that utilize other or additional fuels for formation of other or additional products. By way of example, a fuel can include water and carbon dioxide in formation of syngas. Fuels to an SOEC system can include, without limitation, water, carbon dioxide, nitrogen, methane, ethane, as well as combinations of fuels.

Fuel can be provided to at least the side of the cell 210 including the anode 204. In some embodiments, it may be useful to provide a carrier gas, e.g., air or the like, to the cathode side of the cell, according to known practice. In general, fuel to the cell can be preheated to a suitable temperature (e.g., about 500° C. to about 850° C.). The feed hoses 220, 221, 222, can be in communication with valves, pumps, sensors, etc. as known in the art. As such, a single feed line may be composed of several sections of hose in conjunction with connectors, fittings, etc., providing connection to such system components. The discharge hose 223 and the discharge hose 224 can carry the reaction products, e.g., oxygen and hydrogen, to additional system components such as a water separator 212, a gaseous product separator 229, etc. Such components can be in fluid communication with one another via additional hoses 226. Separated products of a cell 210 can be delivered via hoses 223, 230, 232. For instance, products can be delivered to a further system, e.g., a chemical formation system, an energy formation system, or for transport or storage. Notably, the hoses 220, 221, 222, 223, 224, 226, 230, 232 as well as connectors, fittings, etc. utilized with the hoses may be formed in accordance with the present invention.

To operate the SOEC 210, fuel (e.g., water) is introduced via feed hose 220 into the cathode side of the electrochemical cell 210. In the illustrated embodiment, a carrier gas (e.g., air) is introduced via feed hose 221 into the anode side of the electrochemical cell 210.

At cathode 204, water is reacted according to the half reaction:

2 H₂O+2 e⁻→H₂+O²⁻

The solid oxide electrolyte 202 allows transport of the oxygen ions formed at the cathode 204 to the anode 206. Typical solid oxide electrolyte materials include dense ionic conductors such as ZrO₂ doped with Y₂O₃ (YSZ), scandia stabilized zirconia (ScSZ), ceria-based materials, and lanthanum gallate-based materials.

At the anode 206, the oxygen ions react according to the half reaction:

2O²⁻→O₂+4e⁻

The oxygen is then discharged from the cell 210 and anode 206 via hose 223 and the hydrogen is then discharged from the cell 210 and cathode 204 via hose 224. In general, hydrogen product will be discharged with water and further separation and purification can be carried out as described.

An electrolyzer system may include secondary components, in addition to the electrochemical cell itself, and in some embodiments, such secondary components can incorporate fluidic member as described. For instance, as illustrated in FIG. 1, FIG. 2, and FIG. 3, the various fluidic members may be formed in accordance with the present invention and these members need not directly feed fluid to/from an electrolyzer cell, but may be utilized in conveyance of fluid to/from a secondary component of the system, such as a valve, a heat exchanger, a gas/liquid separator, a purifier, etc., and thereby be in indirect communication with the electrolyzer cell. Other secondary components as known in the art can likewise utilize a fluidic member as described herein to convey fluid to/from the secondary component. Secondary components of an electrolyzer system can include, without limitation, filters as may be utilized to remove particulates from a feed, purifiers as may be utilized to purify a fuel gas, etc.

In addition, it should be understood that while FIG. 1, FIG. 2, and FIG. 3 illustrate single electrochemical cells, electrolyzer systems as described can include multiple cells forming a single or multiple cell stacks.

The present invention may be better understood with reference to the following examples.

### Test Methods

Melt Viscosity: The melt viscosity (Pa-s) may be determined in accordance with ISO Test No. 11443:2021 at a shear rate of 1,200 s-⁻¹and using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod was 233.4 mm. The melt viscosity is typically determined at a temperature of 310° C.

Melting Temperature: The melting temperature (“Tm”) may be determined by differential scanning calorimetry (“DSC”) as is known in the art. For semi-crystalline and crystalline materials, the melting temperature is the differential scanning calorimetry (DSC) peak melt temperature as determined by ISO 11357:2018. Under the DSC procedure, samples were heated and cooled at 10° C. per minute using DSC measurements conducted on a TA Q2000 Instrument.

Tensile Modulus, Tensile Stress, and Tensile Elongation at Break: Tensile properties may be tested according to ISO Test No. 527-2/1A:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 5 mm/min for tensile strength and tensile strain at break, and 1 mm/min for tensile modulus.

Flexural Modulus and Flexural Stress: Flexural properties may be tested according to ISO Test No. 178:2019 (technically equivalent to ASTM D790-17). This test may be performed on a 64 mm support span. Tests may be run on the center portions of uncut ISO 3167 multi-purpose bars. The testing temperature may be 23° C. and the testing speed may be 1 or 5 mm/min.

Notched Charpy Impact Strength: Notched Charpy properties may be tested according to ISO Test No. ISO 179/1eU:2010) (technically equivalent to ASTM D256-10, Method B). This test may be run using a Type A notch (0.25 mm base radius) and Type 1 specimen size (length of 80 mm, width of 10 mm, and thickness of 4 mm). Specimens may be cut from the center of a multi-purpose bar using a single tooth milling machine. The testing temperature may be 23° C.

Chlorine Content: Chlorine content may be determined according to an elemental analysis using Parr Bomb combustion followed by Ion Chromatography.

Complex Viscosity: The complex viscosity is used herein as an estimate for the “low shear” viscosity of the polymer composition at low frequencies. Complex viscosity is a frequency-dependent viscosity, determined during forced harmonic oscillation of shear stress at angular frequencies of 0.1 and 500 radians per second. Measurements may be determined at a constant temperature of 310° C. and at constant strain amplitude of 3% using an ARES-G2 rheometer (TA Instruments) with a parallel plate configuration (25 mm plate diameter). The gap distance may be kept at 1.5 mm for pellet samples. A dynamic strain sweep may be performed on sample prior to the frequency sweep to find LVE regime and optimized testing conditions. The strain sweep may be done from 0.1% to 100% at a frequency 6.28 rad/s.

### Example 1

Samples 1-5 are formed for use in an electrolyzer hose. The samples are melt-mixed using a 32 mm Coperion co-rotating, fully-intermeshing, twin-screw extruder and include a polyarylene sulfide, impact modifier, heat stabilizer, terephthalic acid, zinc stearate, and/or lubricants. The impact modifier is a random copolymer of ethylene and glycidyl methacrylate having 8 wt. % glycidyl methacrylate content and a melt flow index of 5 g/10 min at 190° C. The resulting compositions are set forth in more detail in the table below.

| | Sample 1 | Sample 2 | Sample 3 | Sample 4 | Sample 5 |
|---|---|---|---|---|---|
| PPS | 73.45 | 73.15 | 72.95 | 72.65 | 72.90 |
| Impact | 25 | 25 | 25 | 25 | 25 |
| Modifier 1 | | | | | |
| Terephthalic | 1.25 | 1.25 | 1.25 | 1.25 | 1 |
| Acid | | | | | |
| Zinc Stearate | 0 | 0.3 | 0.5 | 0.8 | 0.5 |
| Lubricant | 0.3 | 0.3 | 0.3 | 0.3 | 0.3 |
| Heat Stabilizer | — | — | — | — | 0.3 |

Following formation, the samples are tested for a variety of physical characteristics. The results are set forth below.

| | Sample 1 | Sample 2 | Sample 3 | Sample 4 | Sample 5 |
|---|---|---|---|---|---|
| Melt Viscosity (Pa · s) at 1200 s⁻¹ | 388 | 445 | 500 | 560 | 582 |
| Melt Viscosity (10⁵ Pa · s) at 0.1 rad/s | 1.8 | NA | 2.4 | 2.75 | NA |
| Tensile Modulus (MPa) | 1,590 | 1,580 | 1,550 | 1,540 | 1,500 |
| Tensile Break Stress (MPa) | 41 | 41 | 41 | 41 | 41 |
| Tensile Break Strain (%) | 63 | 70 | 88 | 80 | 78 |
| Charpy Notched Impact Strength | 39 | 41 | 44 | 45 | 49 |
| (kJ/m²) at 23° C. | | | | | |
| Charpy Notched Impact Strength (kJ/m²) | 10 | 13 | 16 | 15 | 18 |
| at −30° C. | | | | | |

### Example 2

Samples 6-14 are formed for use in an electrolyzer hose. The samples are melt-mixed using a 32 mm Coperion co-rotating, fully-intermeshing, twin-screw extruder and include a polyarylene sulfide, impact modifier, heat stabilizer, terephthalic acid, zinc stearate, aluminum monostearate, zinc neodecanoate, and/or lubricants. The resulting compositions are set forth in more detail in the table below.

| Sample | 6 | 7 | 8 | 9 | 10 | 11 | 12 | 13 | 14 |
|---|---|---|---|---|---|---|---|---|---|
| PPS | 84.7 | 83.7 | 84.4 | 84.4 | 84.4 | 74.2 | 71.7 | 57.5 | 57.4 |
| Impact Modifier | 15.0 | 15.0 | 15.0 | 15.0 | 15.0 | 25.0 | 25.0 | 10.0 | 10.0 |
| Terephthalic Acid | — | 1.0 | 0.2 | 0.2 | 0.2 | 0.4 | 0.4 | — | — |
| Zinc Stearate | — | — | 0.1 | — | — | 0.1 | 0.1 | — | 0.1 |
| Aluminum Monostearate | — | — | — | 0.1 | — | — | — | — | — |
| Zinc Neodecanoate | — | — | — | — | 0.1 | — | — | — | — |
| Glass Fibers | | | | | | | | 30 | 30 |
| Heat Stabilizer | — | — | 0.3 | 0.3 | 0.3 | 0.3 | 0.3 | — | — |
| Lubricant | 0.3 | 0.3 | — | — | — | — | — | — | — |
| Black Color | — | — | — | — | — | — | 2.5 | 2.5 | 2.5 |

Following formation, the samples are tested for a variety of physical characteristics. The results are set forth below.

| Sample | 6 | 7 | 8 | 9 | 10 | 11 | 12 | 13 | 14 |
|---|---|---|---|---|---|---|---|---|---|
| Tensile Modulus (MPa) | 2300 | 2200 | 2108 | 1988 | 2253 | 1650 | 1685 | 9216 | 9435 |
| Tensile Stress at Break | 50 | 50 | 47 | 36 | 49 | 42 | 44 | 135 | 133 |
| (MPa) | | | | | | | | | |
| Tensile Strain at Break (%) | 25 | 40 | 39 | 11 | 32 | 90 | 86 | 1.95 | 2.1 |
| Flexural Modulus (MPa) | 2400 | 2200 | 2253 | — | — | 1700 | 1697 | — | — |
| Flexural Stress at 3.5% | — | 68 | 67 | — | — | 50 | 49 | — | — |
| (MPa) | | | | | | | | | |
| Charpy Notched Strength | 30 | 40 | 55 | 46 | 60 | 65 | 63 | 10.4 | 12.4 |
| at 23° C. (kJ/m²) | | | | | | | | | |
| Charpy Notched Strength | 9 | 10 | 28 | 16 | 39 | 48 | 46 | 8.4 | 9.4 |
| at −30° C. (kJ/m²) | | | | | | | | | |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. An electrolyzer system comprising an electrochemical cell and an electrolyzer fluidic member configured for conveyance of a fluid within the electrolyzer system the electrochemical cell, wherein the electrolyzer fluidic member comprises a polymer composition that includes a polyarylene sulfide.

2. The electrolyzer system of claim 1, wherein the polymer composition has a melt viscosity of about 2,000 Pa-s or less as determined in accordance with ISO 1143:2021 at a temperature of about 310° C. and a shear rate of 1,200 seconds⁻¹.

3. The electrolyzer system of claim 1, wherein the polymer composition has a chlorine content of about 1,200 ppm or less.

4. The electrolyzer system of claim 1, wherein the polymer composition exhibits a notched Charpy impact strength of about 20 kJ/m² or more as determined at a temperature of 23° C. in accordance with ISO Test No. 179-1:2010.

5. The electrolyzer system of claim 1, wherein the polymer composition exhibits a notched Charpy impact strength of about 10 kJ/m² or more as determined at a temperature of −30° C. in accordance with ISO Test No. 179-1:2010.

6. The electrolyzer system of claim 1, wherein the polymer composition exhibits a tensile strength of about 20 MPa or more; a tensile break strain of about 20% or more; and/or a tensile modulus of about 10,000 MPa or less, as determined in accordance with ISO 527:2019 at a temperature of 23° C.

7. The electrolyzer system of claim 1, wherein the polymer composition exhibits a flexural strength of about 20 MPa or more and/or a flexural modulus of about 10,000 MPa or less as determined in accordance with ISO 178:2019 at a temperature of 23° C.

8. The electrolyzer system of claim 1, wherein the polymer composition exhibits a hydrogen transmission rate of about 30 ml/m²*day or less as determined in accordance with ASTM D1434-82 (2015) (volumetric method) at a temperature of about 23° C. and pressure difference of 1 atmosphere.

9. The electrolyzer system of claim 1, wherein the polymer composition exhibits an oxygen transmission rate of about 30 ml/m²*day or less as determined in accordance with ASTM D1434-82 (2015) (volumetric method) at a temperature of about 23° C. and pressure difference of 1 atmosphere.

10. The electrolyzer system of claim 1, wherein the polyarylene sulfide is a polyphenylene sulfide.

11. The electrolyzer system of claim 1, wherein polyarylene sulfides constitute from about 40 wt. % to 100 wt. % of the polymer composition.

12. The electrolyzer system of claim 1, wherein the polymer composition further comprises an impact modifier.

13. The electrolyzer system of claim 12, wherein impact modifiers are present in the polymer composition in an amount of from about 5 to about 50 parts by weight per 100 parts by weight of polyarylene sulfides in the polymer composition.

14. The electrolyzer system of claim 12, wherein the impact modifier includes an epoxy-functionalized olefin copolymer.

15. The electrolyzer system of claim 14, wherein the epoxy-functionalized olefin copolymer contains an ethylene monomeric unit.

16. The electrolyzer system of claim 14, wherein the epoxy-functionalized olefin copolymer contains an epoxy-functional (meth)acrylic monomeric component.

17. The electrolyzer system of claim 16, wherein the epoxy-functional (meth)acrylic monomeric component is derived from glycidyl acrylate, glycidyl methacrylate, or a combination thereof.

18. The electrolyzer system of claim 12, wherein the polymer composition is a crosslinked product formed by blending the impact modifier with a crosslinking system.

19. The electrolyzer system of claim 18, wherein the crosslinking system includes a metal carboxylate.

20. The electrolyzer system of claim 19, wherein the metal carboxylate is a metal salt of a fatty acid.

21. The electrolyzer system of claim 20, wherein the salt contains a divalent metal cation.

22. The electrolyzer system of claim 20, wherein the fatty acid has a carbon chain length of from about 8 to about 22 carbon atoms.

23. The electrolyzer system of claim 18, wherein the crosslinking system comprises a multi-functional crosslinking agent.

24. The electrolyzer system of claim 23, wherein the multi-functional crosslinking agent includes an aromatic dicarboxylic acid.

25. The electrolyzer system of claim 1, wherein the polymer composition exhibits a complex viscosity of 1,000 Pa-s or more, as determined by a parallel plate rheometer at an angular frequency of 0.1 radians per second, temperature of 310° C., and constant strain amplitude of 3%.

26. The electrolyzer system of claim 1, wherein the electrochemical cell contains a proton exchange polymer electrolyte membrane or an anion exchange polymer electrolyte membrane.

27. The electrolyzer system of claim 1, wherein the electrochemical cell comprises a tank configured to retain an aqueous alkaline electrolyte liquid.

28. The electrolyzer system of claim 1, wherein the electrochemical cell contains a solid oxide electrolyte layer.

29. The electrolyzer system of claim 1, wherein the electrolyzer fluidic member is utilized to supply water to an anode and/or to a cathode of the electrochemical cell.

30. The electrolyzer system of claim 29, wherein the water is a liquid.

31. The electrolyzer system of claim 29, wherein the water is in the form of steam.

32. The electrolyzer system of claim 1, wherein the electrolyzer fluidic member is utilized to convey a gas to or from the electrochemical cell.

33. The electrolyzer system of claim 32, wherein the gas comprises hydrogen or oxygen.

34. The electrolyzer system of claim 1, wherein the electrolyzer fluidic member is utilized to convey a fluid to or from a secondary component of the electrolyzer system.

35. The electrolyzer system of claim 1, wherein the electrolyzer fluidic member comprises a hose, a tube, or a pipe that defines a passageway that extends between an inlet and an outlet.

36. The electrolyzer system of claim 1, wherein the electrolyzer fluidic member comprises a connector or a fitting.

37. The electrolyzer system of claim 1, wherein the electrolyzer fluidic member contains multiple outlets.

38. The electrolyzer system of claim 1, wherein the electrolyzer fluidic member contains multiple angular displacements.

39. The electrolyzer system of claim 1, wherein at least a portion of the electrolyzer fluidic member has an outer diameter of from about 1 to about 50 millimeters.

40. The electrolyzer system of claim 1, wherein the electrolyzer fluidic member comprises a multi-layer hose, the multi-layer hose comprising the polymer composition in at least one layer.

41. The electrolyzer system of claim 40, wherein the multi-layer hose comprises the polymer composition in an inner layer.

42. The electrolyzer system of claim 40, wherein the multi-layer hose comprises the polymer composition in an outer layer.

43. The electrolyzer system of claim 40, wherein the multi-layer hose further comprises another polymer composition comprising an elastomer, a polyolefin, a polyamide, a fluoropolymer, or a polyvinyl chloride in at least one layer.

44. The electrolyzer system of claim 40, wherein the multi-layer hose comprises a thermoplastic elastomer in at least one layer.
